(19) United States
(12) Patent Application Publication
(10) Pub. No.: US 2026/0254782 A1
(43) Pub. Date: Aug. 27, 2026

(54) ENHANCED VISUAL INDICATORS FOR DESIGNATED PARTICIPANTS COMMUNICATING REAL-TIME TEXT

(71) Applicant: Microsoft Technology Licensing, LLC, Redmond, WA (US)

(72) Inventors: Christopher M. SANO, Seattle, WA (US); Brett D. HUMPHREY, Seattle, WA (US); Noe BARRAGAN, Irvine, CA (US)

(21) Appl. No.: 19/060,475

(22) Filed: Feb. 21, 2025

(51) Int. Cl. H04L 51/04; G06F 40/30

(52) U.S. Cl. CPC H04L 51/04; G06F 40/30

(57) ABSTRACT

The disclosed techniques provide enhanced control of visual indicators providing attribution to participants communicating via real-time text (RTT) in an online meeting. The disclosed techniques also provide dynamic control of text-to-speech conversion of RTT during online meetings. The display of RTT and the text-to-speech conversion for RTT allows users to hear and visualize content shared through RTT. A person's name and/or image is highlighted if that person is designated as having a prerequisite while they are communicating text in RTT mode. The system also acknowledges such users as an “active speaker” so the content shared in RTT is also recorded equitably in meeting records and used in AI models for generating transcripts, summaries, tasks, etc.

### BACKGROUND

There are a number of different types of collaborative systems that allow users to communicate. For example, some systems allow people to collaborate by sharing content using video streams, audio streams, shared files, chat messages, etc. Some systems manage communication sessions, which are also referred to herein as online meetings, virtual reality sessions, broadcasts, etc. Such sessions can have a distinct start time and an end time that occur on specific dates. People can schedule these sessions on a calendar and have a number of events scheduled throughout the day. Users can schedule meetings in advance, invite other participants, and use various content sharing features such as audio, video, chat, screen sharing, whiteboards, etc.

Although some existing systems provide a number of features that allow people to collaborate during specific events, such systems do not provide an equitable experience for all users. For example, some existing systems do not provide an environment that gives equitable presence for people who are deaf, hard-of-hearing (D/HH), or other types of non-verbal participants who may be at a location, e.g., a library, where they are unable to speak. Some existing systems have user interface features that bring focus to users who are talking in an online meeting. When a person is talking, a user interface may highlight their name or image. Such systems do not have similar features that bring focus to users who primarily rely on text communication. Yet further, such existing systems do not have an optimal feature set when it comes to allowing a non-verbal participant using text communication to communicate with others who may be visually impaired.

In addition to the above-described issues, some existing systems do not provide equitable presence for non-verbal users in other situations. For example, a user may be in a situation where speaking is not safe or feasible. Equitable presence may also not be afforded to other users who may be unable to speak due to an injury, illness, or in a situation where a microphone is not working, etc. In such scenarios, other forms of text communication may be necessary. Without features that can accommodate users in these scenarios, a system may not allow users to effectively communicate with others or have a strong presence in a meeting or a call. Further, if a system does not properly provide attribution to non-verbal participants, e.g., a person communicating using text communication, the system may not properly use that person's shared content in a transcript, meeting summary or in an artificial intelligence (AI) analysis of the meeting content.

### SUMMARY

The techniques disclosed herein provide enhanced control of visual indicators providing attribution to select participants communicating via real-time text (RTT) in an online meeting. The disclosed techniques also provide dynamic control of text-to-speech conversions of RTT during online meetings. RTT is the ability for someone to send a text message on a character-by-character basis to other participants of a meeting. The system disclosed herein integrates RTT, live video streams, live audio streams, chat messages, live captions, and other shared meeting content all in one central experience. The display of RTT and the text-to-speech conversion of the RTT allows users to hear and visualize content shared through RTT. This integrated experience allows users to participate equitably by making RTT accessible to users regardless of the operating mode they are in. The system also generates graphical elements to highlight a video, image, or a name of a user to show that they are actively providing RTT. Such features bring focus to RTT users as if they are an active speaker in a meeting. In some embodiments, a person's name and/or image is highlighted if that person is designated as having a prerequisite while they are communicating text in RTT mode. For instance, a user input or a user profile can indicate that person has a prerequisite because they are in a public location and are unable to speak into a microphone, they are deaf or hard-of-hearing (D/HH), etc. The system also acknowledges RTT contributors as “active speakers” so the content shared in RTT is also recorded equitably in meeting records and used in AI models for building summaries, tasks, etc.

In some embodiments, during an online conference, in response to two or more attendees activating a RTT mode, the system determines if those participants are associated with a prerequisite. A prerequisite can include an input or a user preference indicating that specific people require one or more accommodations in a meeting, e.g., if a person is in a public area or unable to speak, D/HH, etc. If two participants are in RTT mode, and a first participant is designated as having a prerequisite, and a second participant does not have a prerequisite, the system will provide a graphical indicator in association with the first participant's name or image to show that the first participant is an active participant. The system does not display a visual indicator for the second participant until the first participant stops typing text for a predetermined time, and the second participant continues contributing RTT. The system can also designate both participants in RTT mode as active speakers for giving them attribution that is similar to the attribution that is provided to a verbal participant who is actively speaking. These features enable people who are D/HH, or others in situations where text communication is needed, to participate equitably in real-time conversations. These features also enable a system to equally use RTT from non-verbal participants and voice input from verbal participants for meeting notes, transcripts, meeting summaries and other data that may be used as an input to an AI system for generating additional meeting content. The disclosed features allow communication systems to create a more inclusive experience for everyone participating in meetings.

By providing equitable meeting presence and controls for displaying RTT, the system described herein provides benefit over existing systems because the user interface can more accurately provide context of a meeting by prominently displaying contributions of RTT participants, especially for those who have a special designation for a particular meeting. In addition, the described techniques provide other benefits over existing systems by generating more accurate summaries and other meeting content by including RTT contributions, while also highlighting RTT users having a special designation. Having both verbal and non-verbal contributors designated as “active speakers” allows a system to provide benefits that increase the efficiency and security of a computing system by reducing the number of times a user needs to interact with a computing device to obtain information or display information. Having both RTT contributions to be displayed in a text format and played in a text-to-speech generator also allows for improved human interaction with a system. For example, if users in a meeting miss shared content because of inefficient human interactions, they have to resort to prolonged meetings, extensive use of meeting recordings, or require duplicate copies of previously shared content to be sent over email systems, etc. Thus, various computing resources such as network resources, memory resources, and processing resources can be reduced by mitigating scenarios where content is missed or misinterpreted during a meeting. Also, the disclosed techniques of automatically using RTT content for meeting summaries and for providing correct attribution to RTT content, the system can reduce the need to duplicate the communication of meeting content. These improved efficiencies can also reduce exposed attack vectors by mitigating duplicate communication of shared content.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a data structure that defines prerequisites for participants of a meeting.

FIG. 2A is a block diagram of a system for providing enhanced controls for real-time text in meetings, this figure also shows an example user interface (UI) for a communication session, e.g., an online meeting.

FIG. 2B shows an example of a user interface control element for accessing a menu having a real-time text mode option for a first user.

FIG. 2C shows an example of a user interface control element for activating a real-time text mode for a first user during a meeting.

FIG. 2D shows an example of a notification describing the features of the real-time text mode to the first user.

FIG. 2E shows an example of a user interface control element for activating a real-time text mode for a second user during a meeting.

FIG. 2F shows an example of a notification describing the features of the real-time text mode to the second user.

FIG. 3 shows an example of a meeting UI that is displayed once the real-time text mode is invoked for the first user and the second user, this UI showing a highlight for the first user since the first user has a prerequisite.

FIG. 4 shows a scenario where a visual indicator is transitioned from a first participant to a second participant when the first participant stops providing RTT, while having a prerequisite and while the second participant continues providing RTT.

FIG. 5A shows a phase of RTT mode where a first character is provided as an input and communicated to computers of participants of a meeting while the system is in the real-time text mode.

FIG. 5B shows a phase of RTT mode where a second character that is provided as an input and communicated to computers of participants of a meeting while the system is in the real-time text mode.

FIG. 5C shows a phase of RTT mode where a third character that is provided as an input and communicated to computers of participants of a meeting while the system is in the real-time text mode.

FIG. 5D shows a phase of RTT mode where a fourth character that is provided as an input and communicated to computers of participants of a meeting while the system is in the real-time text mode.

FIG. 5E shows a phase of RTT mode where a fifth character that is provided as an input, and communicated to computers of participants of a meeting while the system is in the real-time text mode.

FIG. 5F shows a phase of RTT mode where a sixth character that is provided as an input and communicated to computers of participants of a meeting while the system is in the real-time text mode.

FIG. 5G shows a phase of RTT mode where a delete control character that is provided as an input and communicated to computers of participants of a meeting while the system is in the real-time text mode.

FIG. 5H shows a phase of RTT mode where a delete control character that is provided as an input and communicated to computers of participants of a meeting while the system is in the real-time text mode.

FIG. 5I shows a phase of RTT mode where a ninth character that is provided as an input, and communicated to computers of participants of a meeting while the system is in the real-time text mode.

FIG. 5J shows a phase of RTT mode where a tenth character that is provided as an input, and communicated to computers of participants of a meeting while the system is in the real-time text mode.

FIG. 5K shows a phase of RTT mode where an eleventh character that is provided as an input, and communicated to computers of participants of a meeting while the system is in the real-time text mode.

FIG. 6 shows a block diagram of a system utilizing a large language model to generate control data.

FIG. 7 is a flow diagram showing aspects of a routine for implementing aspects of the disclosed techniques.

FIG. 8 is a diagram illustrating a distributed computing environment capable of implementing aspects of the techniques and technologies presented herein.

FIG. 9 is a computer architecture diagram illustrating a computing device architecture for a computing device capable of implementing aspects of the techniques and technologies presented herein.

### DETAILED DESCRIPTION

The techniques disclosed herein provide enhanced control of visual indicators providing attribution to participants communicating via real-time text (RTT) in an online meeting. The disclosed techniques also provide dynamic control of text-to-speech conversions of RTT during online meetings. The system disclosed herein integrates RTT, live video streams, live audio streams, chat messages, live captions, and other shared meeting content all in one central experience. The display of RTT and the text-to-speech conversion for RTT allows users to hear and visualize content shared through RTT. This integrated experience allows users to participate equitably by making RTT accessible to users regardless of the operating mode they are in. The system also generates visual indicators to highlight a video, image, or a name of a user to show that they are actively providing RTT. Such features bring focus to RTT users as if they are an active speaker in a meeting. In some embodiments, a person's name and/or image is highlighted if that person is designated as having a prerequisite while they are communicating text in RTT mode. For instance, a user input or a user profile can indicate that person has a prerequisite because they are in a public location and are unable to speak into a microphone, they are deaf or hard-of-hearing (D/HH), etc.

As summarized above, the system can utilize data defining user prerequisites to control the display of visual indicators. In some embodiments, a system allows a user to designate that he/she has a prerequisite, e.g., that they are a non-verbal participant (deaf/hard to hear/those attending a meeting at a public/quiet place that they cannot speak) through a manual selection or by the use of an automatic profile designation, e.g., an accessibility designation. One or more users can provide an input before or during a meeting to indicate that they have a prerequisite. In another embodiment, the system can maintain a data structure that defines user settings associating one or more prerequisites with individual participants.

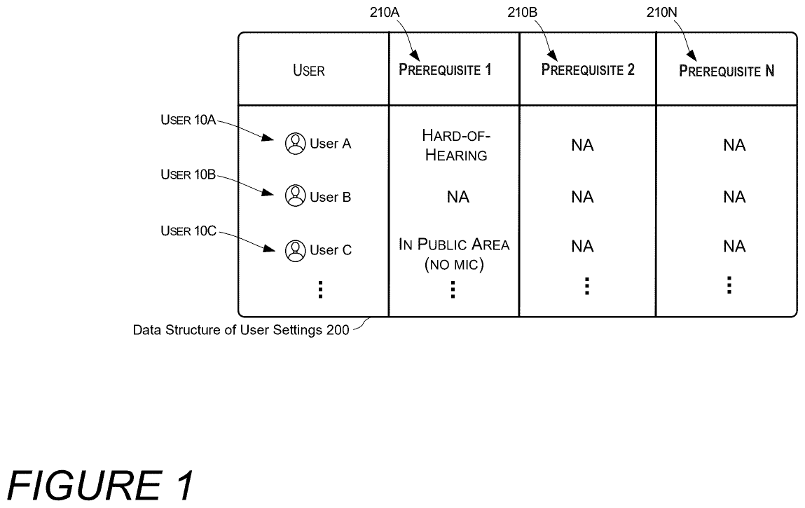

FIG. 1 shows one example of user settings 200 that define individual prerequisites 210 for each user 10. In this example, a first user 10A, User A, has a prerequisite indicating that they are D/HH, a second user 10B, User B, does not have a prerequisite, and a third user 10C, User C, has a prerequisite indicating that they are in a public area and cannot use a microphone. As shown, each user may be associated with multiple prerequisites. As described below, the system can utilize these user settings to control the display of visual indicators when individual users are generating RTT during a meeting. In some embodiments, the settings 200 are configured to persist across multiple communication sessions for each user. This allows a person to establish one or more prerequisites and store those prerequisites in a data structure defining the settings. When that person joins a meeting, the system accesses the settings automatically to determine if that person is associated with any prerequisites.

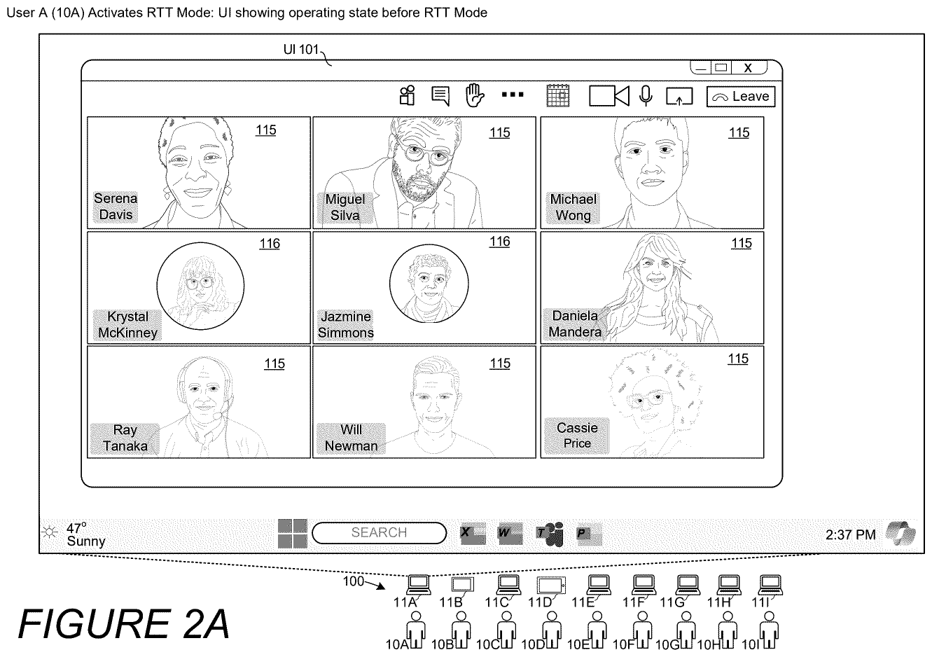

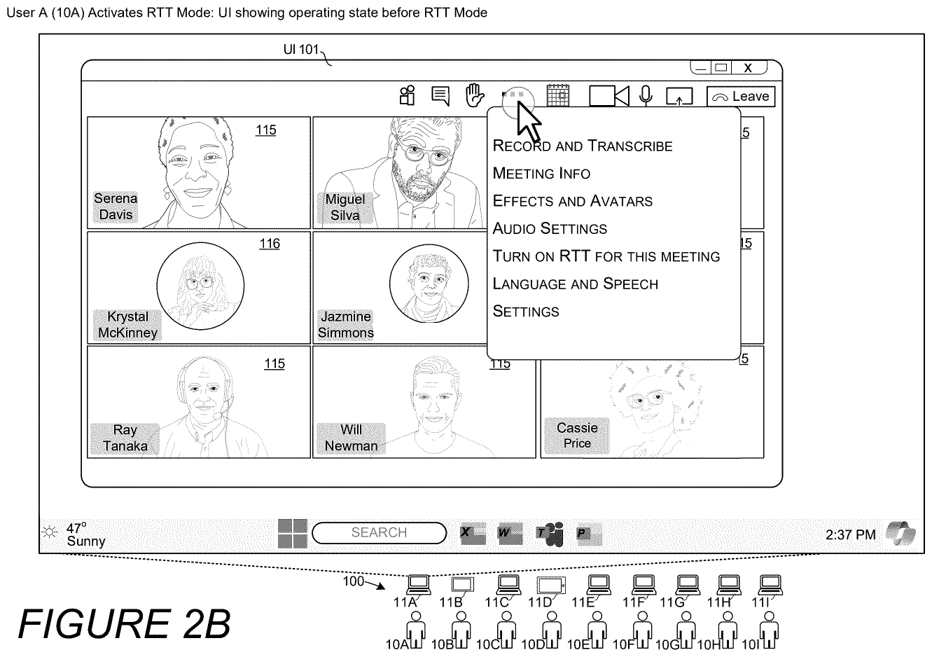

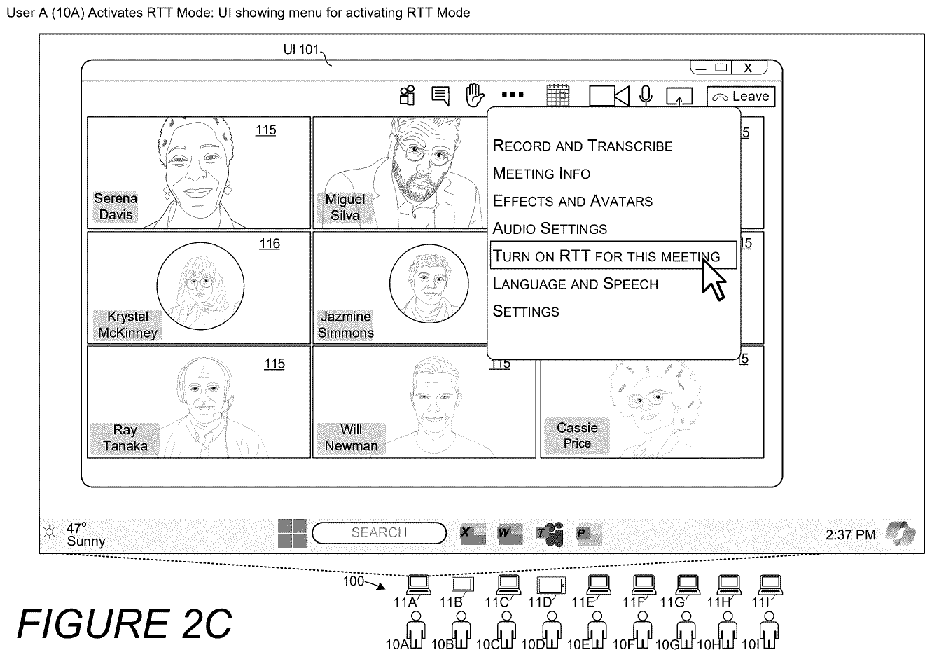

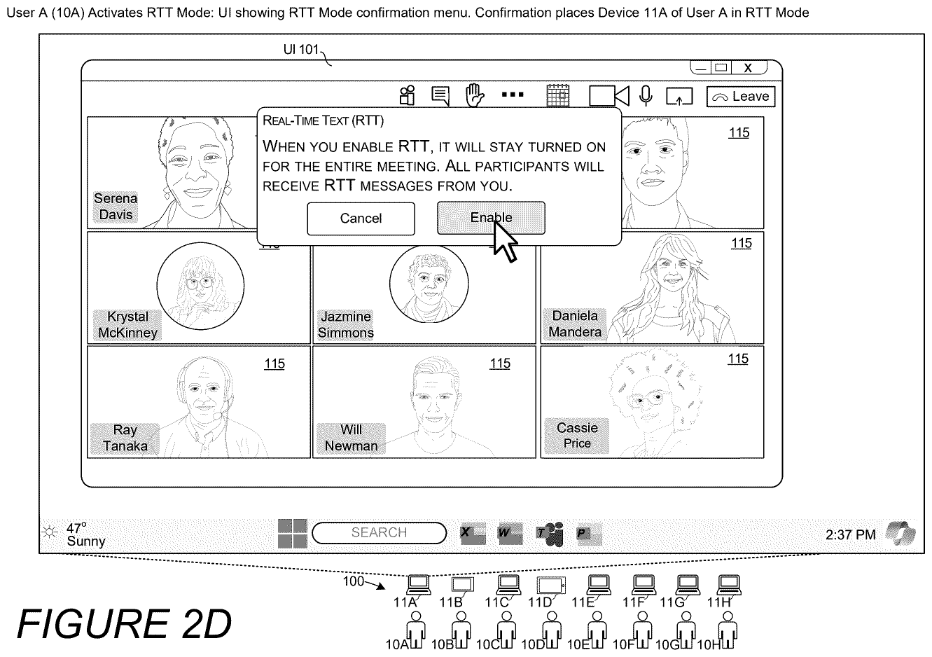

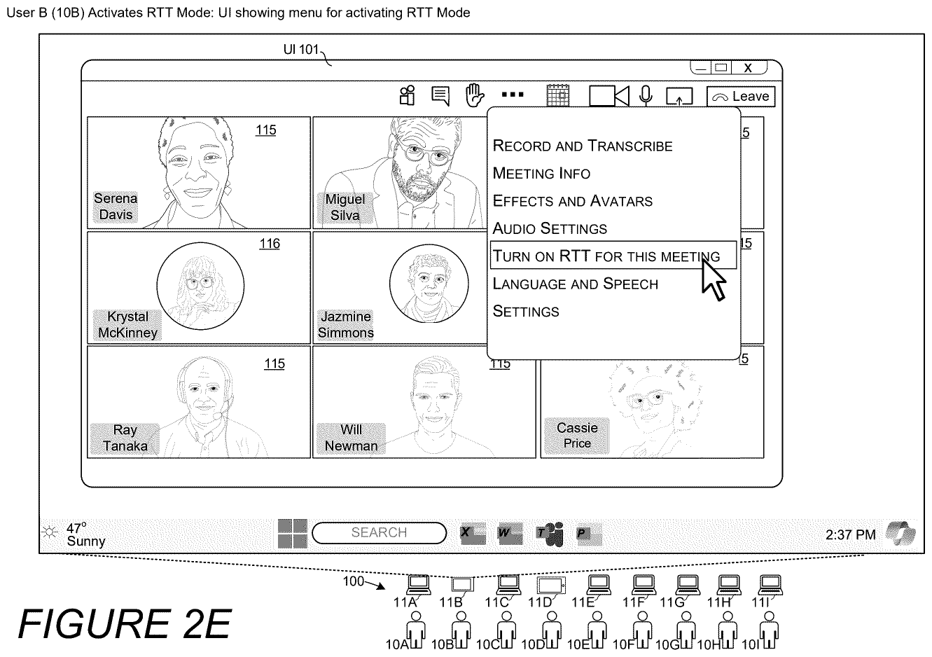

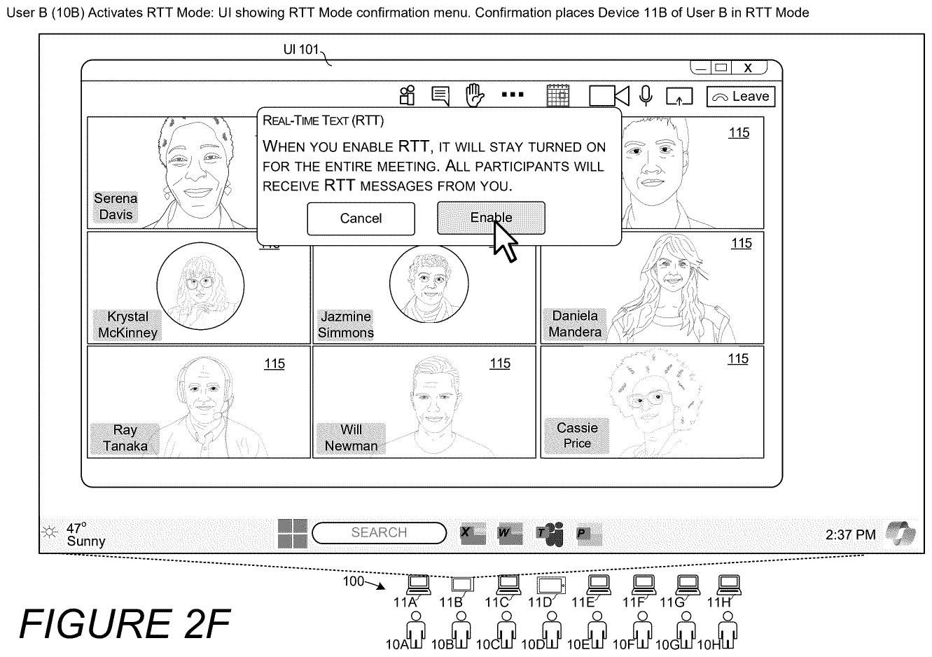

Referring now to FIG. 2A, aspects of a computing system 100 are shown and described below. For illustrative purposes, a system 100 includes a number of computing devices 11A-11I each associated with individual participants 10A-10I of a communication session. The computers are each interconnected using a communication session for sharing video signals, audio signals, and other shared content such as documents, text messages, and RTT. In this example, there are a number of participants 10A-10I in a meeting, where User A 10A, Serena Davis, is associated with a first computing device 11A, User B 10B, Miguel Silva, is associated with a second computing device 11B, User C 10C, Michael Wong, is associated with a third computing device 11C, User D 10D, Krystal McKinney, is associated with a fourth computing device 11D, User E, Jazmine Simmons, is associated with a fifth computing device 11E, User F 10F, Daniela Mandera, is associated with a sixth computing device 11F, User G 10G, Ray Tanaka, is associated with a seventh computing device 11G, and User H 10H, Will Newman, is associated with an eighth computing device 11H, and User I 10I, Cassie Price, is associated with a ninth computing device 11I. Although this example only includes nine participants of an online meeting, it can be appreciated that the system can include any number of devices and a corresponding number of participants for either a call or a meeting.

In order for each participant to communicate RTT with other meeting participants, each user can invoke a RTT mode. FIGS. 2A-2K show an example process of how the RTT mode is invoked for two participants of a meeting: User A 10A and User B 10B. In the example, as shown in FIG. 2A, the system starts in standard message mode, where the system enables each user to communicate text using groups of words that form individual text messages. The message mode involves a protocol where a user enters text into a text field and the text forming a group of words is only communicated to the computers of other participants when the participant enters a particular input key, such as the Return key. In message mode, the messages are sent having a timestamp which reflects the time and date at which the message is sent. While a user is in message mode, the text generated by the user is not sent on a character-by-character basis. The message mode includes the communication of a collection of characters sent in a message, e.g., a collection of characters, in response to a predetermined input. The predetermined input can include any one of: a return character, a “send” button on a UI, a voice command, etc.

FIG. 2B shows a first stage of a process where User A 10A invokes commands to operate in RTT mode. As shown, the meeting UI 101 provides a menu having a selectable control element for activating the RTT mode. In response to the selection of the selectable control element for activating the RTT mode, e.g., by the input shown in FIG. 2C, the system displays a notification shown describing the functionality of the RTT mode. An example of the notification is shown in FIG. 2D. In this example, the notification describes that RTT mode applies to each participant in the meeting. The notification can provide a first option for cancelling the request to activate RTT mode, and a second option for confirming the request. As shown in FIG. 2D, in response to a selection of the second option for confirming the request, the system activates the RTT mode for the first user, User A 10A. Then in, FIGS. 2E and 2F, similar steps are repeated to activate RTT mode for the second user, User B 10B. FIG. 2E shows a notification describing the functionality of the RTT mode to the second user, and FIG. 2F shows that the second user has confirmed the request to invoke RTT mode and communicate to others via RTT.

While the first participant is in RTT mode, RTT provided by the first participant is communicated from the first device 11A of the first participant 10A to the other participants. This can include operations for communicating individual text characters from a first computing device 11A to a first set of computing devices 11B-11I of a first set of meeting participants 10B-10I on a character-by-character basis. Each of the individual text characters are separately transmitted from the first computing device 11A to the first set of computing devices 10B-10I in response to individual character input entries entered at the first computing device 11A.

In addition, while the second participant is in RTT mode, RTT provided by the second participant is communicated from the second device 11B of the second participant 10B to the other participants. This can include operations for communicating other individual text characters from a second computing device 11B to a second set of computing devices 11B-11I of a second set of meeting participants 10A, 10C-10I on a character-by-character basis. Each of the individual text characters are separately transmitted from the second computing device 11B to the second set of computing devices 10A, 10C-10I in response to individual character input entries entered at the second computing device 11B.

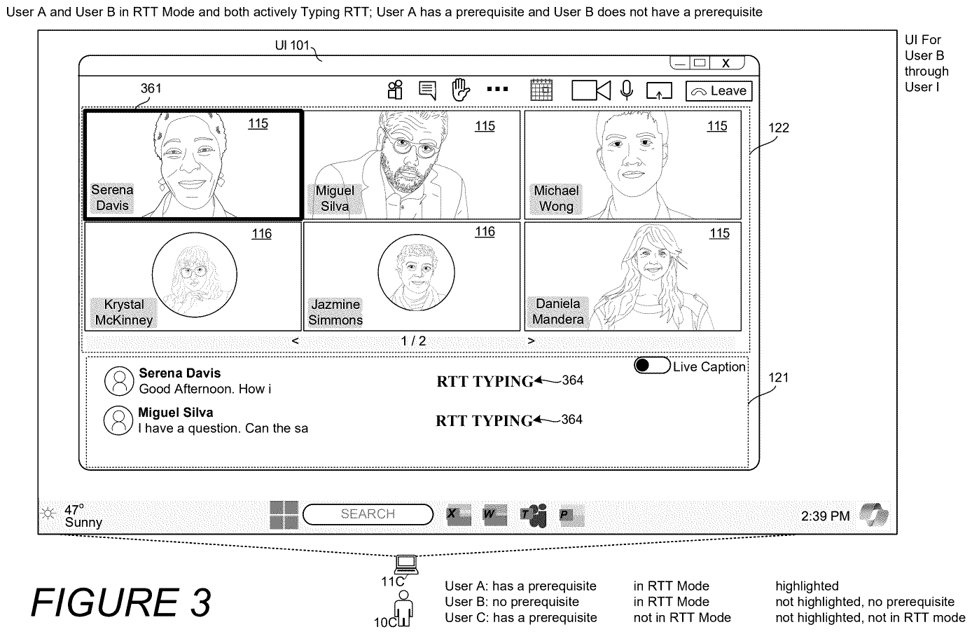

FIG. 3 shows a resulting user interface arrangement 101 that is generated while both the first user and the second user are in RTT mode. To illustrate the UI features, the UI 101 is displayed on the device of the third participant User C, while both the first participant and the second participant are in RTT mode providing RTT text. This user interface can also be displayed to the other participants.

While the first participant is composing RTT in RTT mode, and since the first participant has a prerequisite, the system causes a display of a visual indictor 361 showing the status of first participant to other participants present in the meeting. In this case, the visual indictor 361 is a highlight (or a border) around a rendering 115 of the first participant. The visual indictor 361 can also include a highlight around the participant's name or other identifier for the participant. Also shown in FIG. 3, the system does not generate a highlight for the other participants, e.g., User B, providing RTT if they do not have one or more designations, e.g., a prerequisite. Similarly, even though User C has a prerequisite, the system does not show a highlight for that participant because User C is not in RTT mode. Thus, a highlight or visual indicator showing a non-verbal participant as an “active speaker” is only displayed when that participant has a prerequisite and if they are in RTT mode providing RTT to the meeting participants.

In some embodiments, the highlight around the designated participant's name or image may also be generated when that participant is also typing a message in standard message mode. Thus, when a participant is composing a RTT message or a text message, at which time the system provides a visual indication about the participant to other participants present in the meeting, but the system does not highlight other users typing using RTT or text messages if they do not have such designations, such as the having a D/HH prerequisite. Such embodiments can include operations for determining that the first participant 10A is associated with the at least one prerequisite 210A while the first participant is in the real-time text mode actively communicating real-time text or actively typing a text message in message mode, and determining that the second participant (10B) is not associated with the one or more prerequisites (210). In response to determining that the first participant 10A is associated with the at least one prerequisite 210A while the first participant is in the real-time text mode actively communicating real-time text or actively typing the text message in message mode, and determining that the second participant 10B is not associated with the one or more prerequisites 210, the system displays a visual element in association with the image or the identifier of the first participant (10A), where the visual element indicates an active text input status of the first participant 10A, wherein an identifier or an image of the second participant is displayed without an associated visual element indicating an active text input status of the second participant.

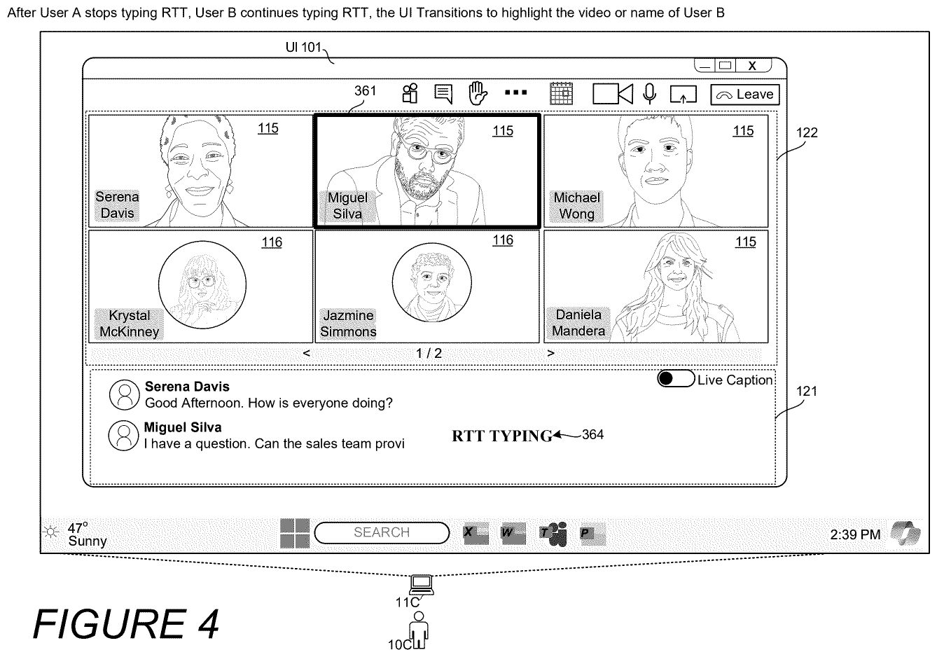

FIG. 4 shows a scenario where the system moves the visual indictor from bringing focus to the first participant to bringing focus to the second participant when the first participant stops typing while the second participant continues to type. This transition occurs when the first participant has a prerequisite and the second participant does not have a prerequisite, and when the first participant stops typing RTT for a predetermined time while the second participant continues to type RTT. In one illustrative example, the system determines if the first participant stopped communicating individual RTT characters for a predetermined period of time. In response to determining that the first participant stopped communicating individual RTT characters for the predetermined period of time, and in response to determining that the second participant is still communicating the other individual RTT characters within the predetermined period of time, the system: (1) removes the display of the visual element in association with the image or the identifier of the first participant 10A and (2) displays a second visual element in association with an image or an identifier of the second participant 10B. Also shown in FIG. 3 and FIG. 4, the user interface also includes RTT status indicators 364 that provide notice when participants are actively typing RTT.

FIG. 3 and FIG. 4 also show that the system does not initially display a visual indicator 361 for other participants that are not in RTT mode or not associated with a prerequisite. In the present example, the system accesses the settings and determines that the first participant is associated with a prerequisite, the second participant is not associated with a prerequisite, and the third participant is associated with a prerequisite. Since the first participant is the only user that meets both conditions, e.g., in RTT mode and having a prerequisite, the system only participant having a highlighted name or image. The second participant is not highlighted because they are not associated with a prerequisite and the third participant is not highlighted because they are not in RTT mode.

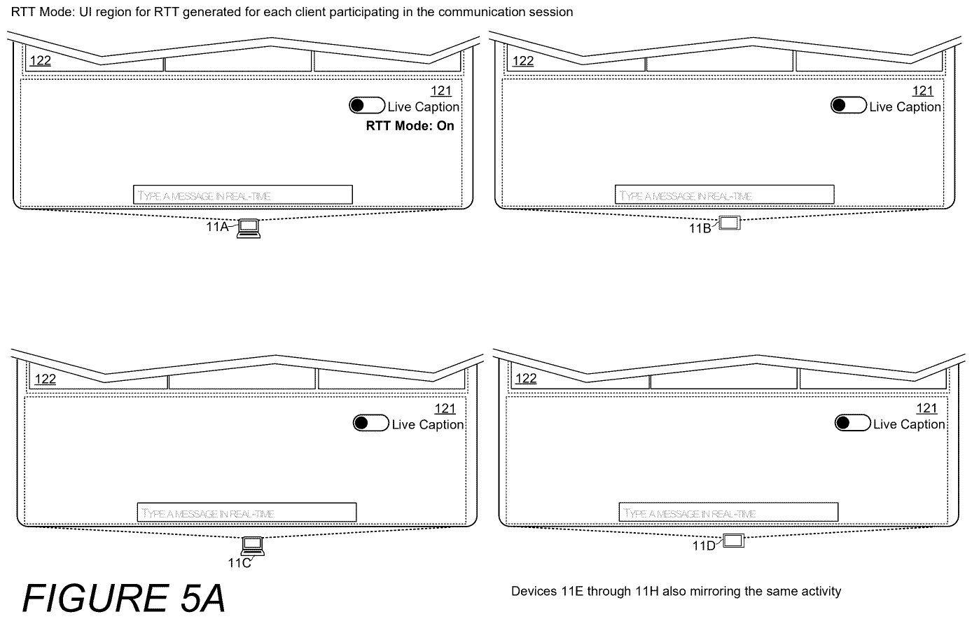

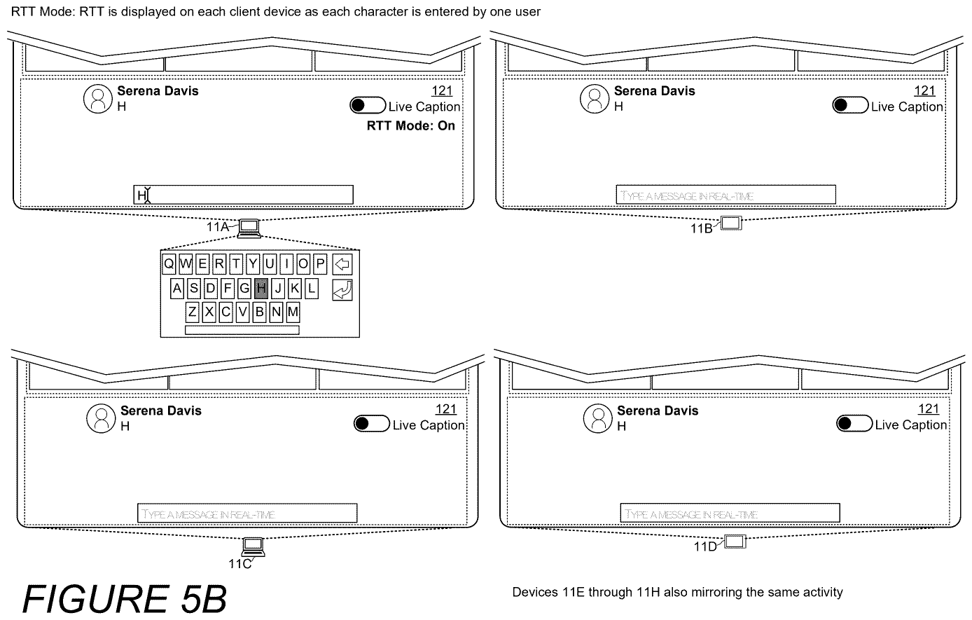

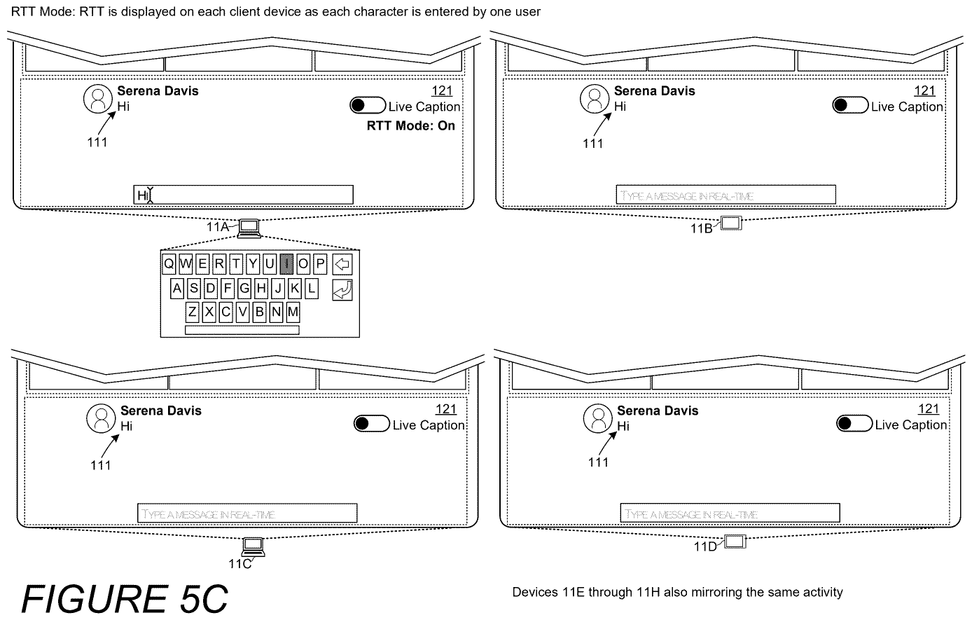

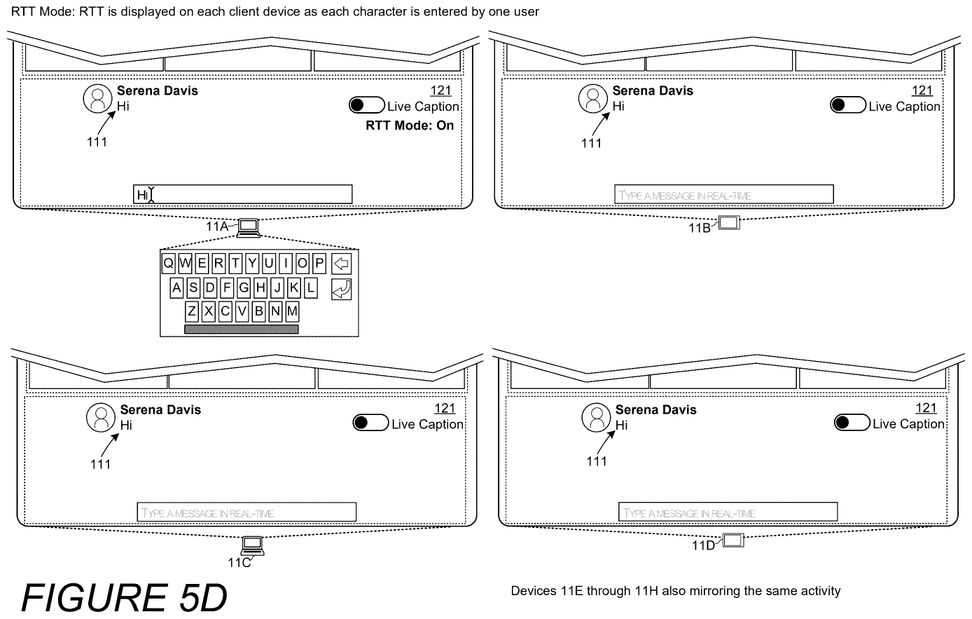

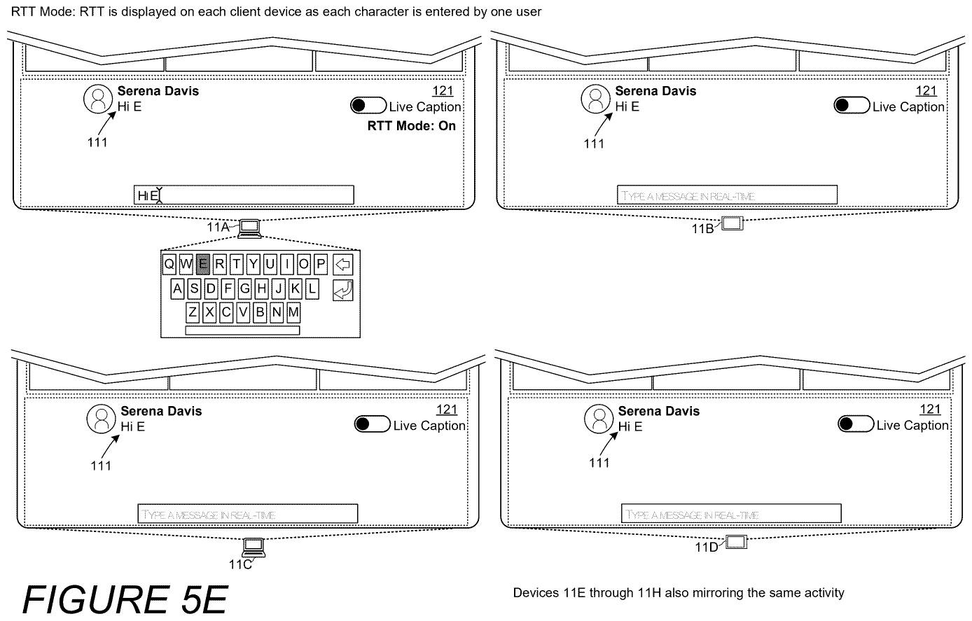

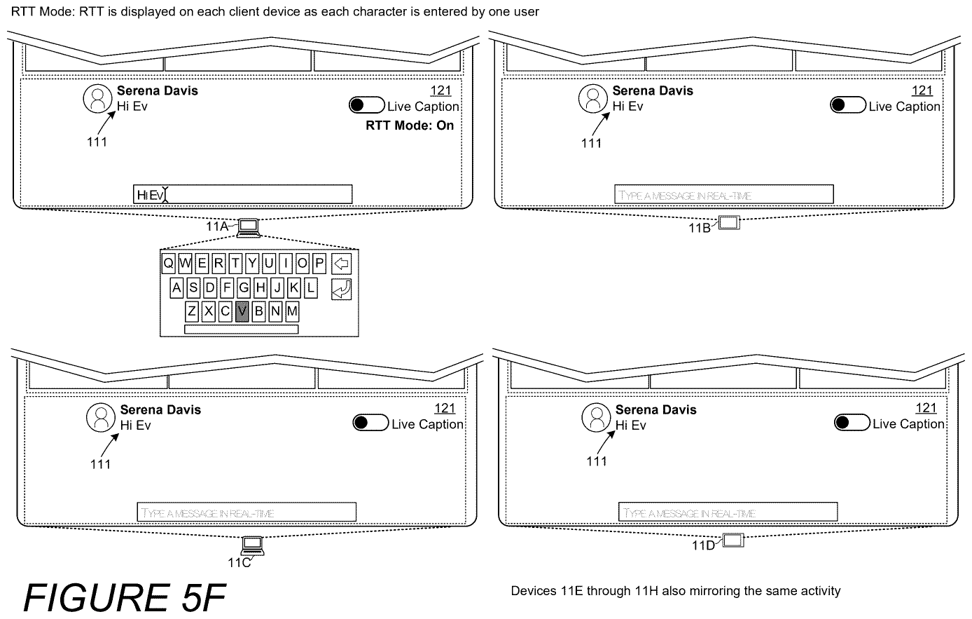

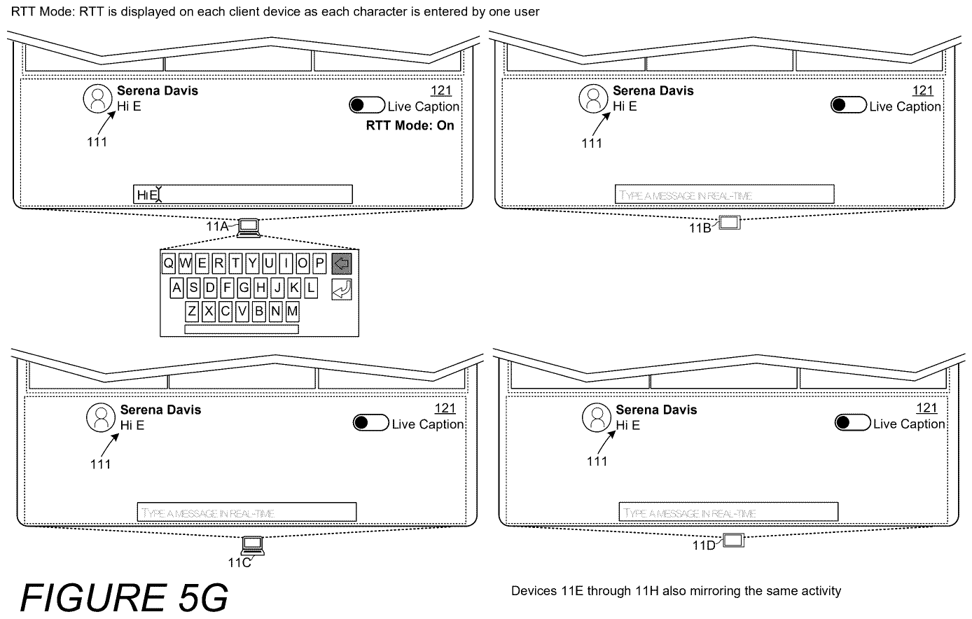

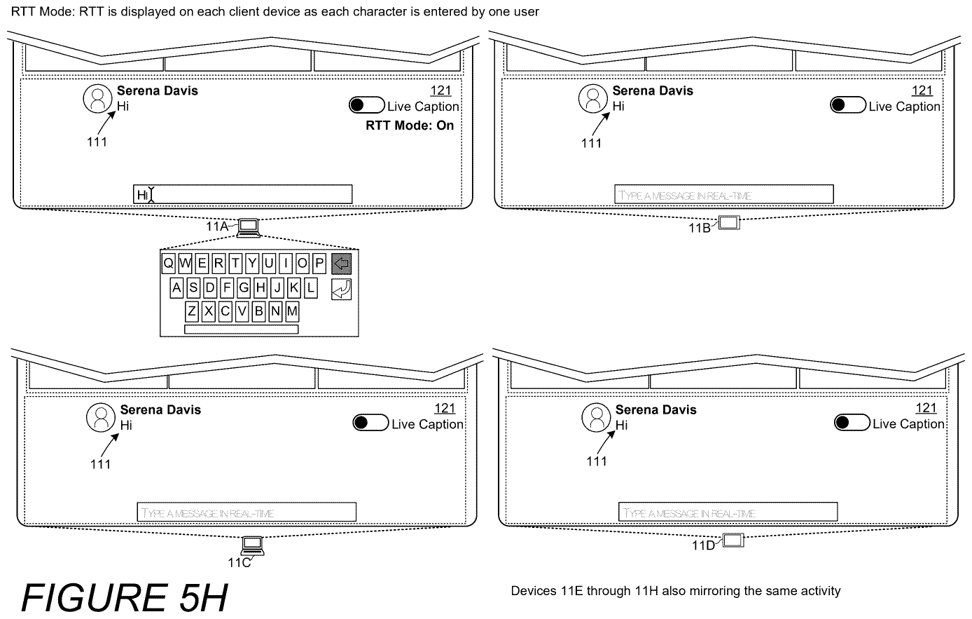

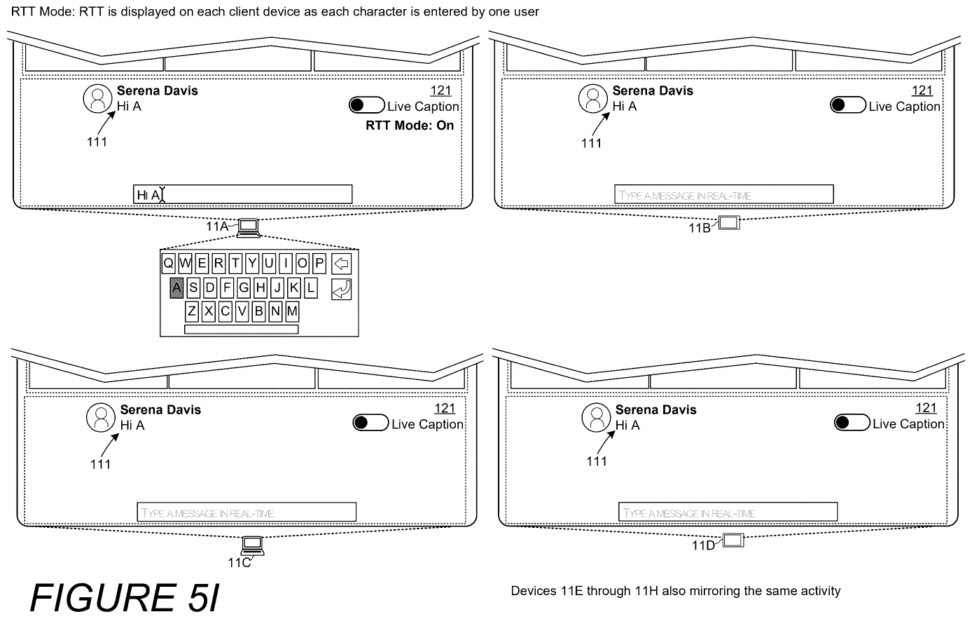

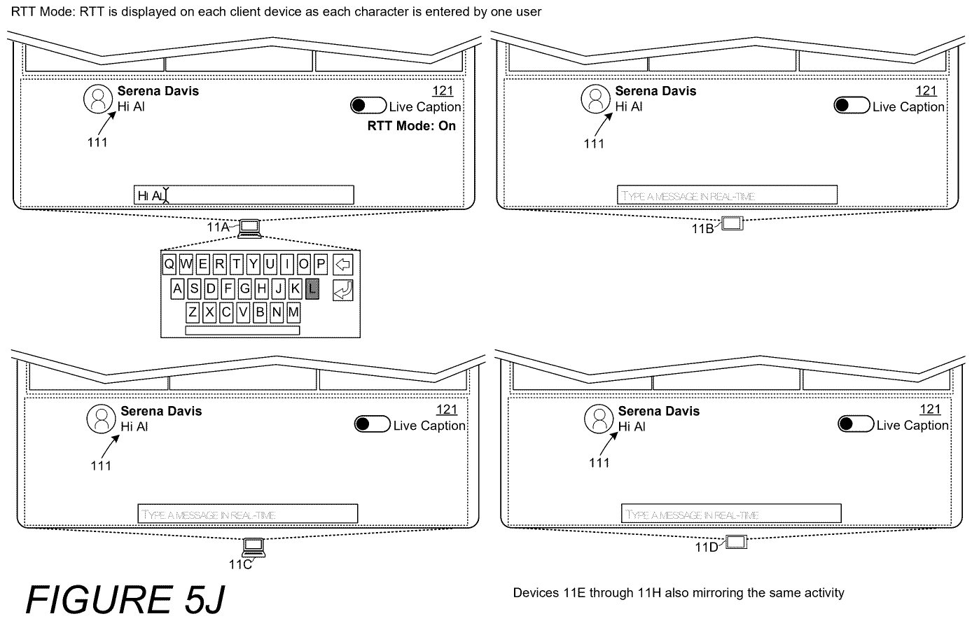

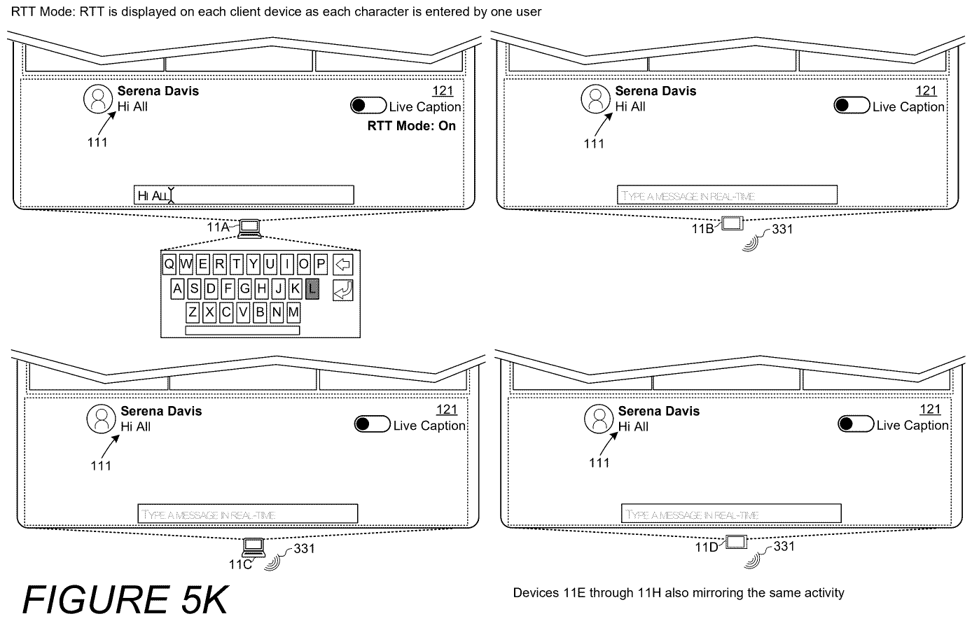

As summarized above, RTT is the ability for someone to send a text message on a character-by-character basis to other participants of a meeting. For illustrative purposes, FIGS. 5A-5K show an example of how RTT is communicated from a computer of an RTT participant to devices of other participants of a meeting. In addition, this example shows how the device of each participant receiving RTT can produce a computer-generated voice from a text-to-speech conversion of the RTT.

When a RTT participant, such as User A 10A, activates RTT mode for a meeting, all users receive RTT that is generated by the device of the RTT participant, and each device receiving RTT generates a UI that displays RTT on a character-by-character basis. As shown in FIG. 5A, the UI for each participant includes a first region 121 reserved for RTT 111 and a second region 122 reserved for video streams and shared files. The second region also referred to herein as the meeting “stage.”

While in RTT mode, as shown in FIG. 5B, when a participant, such as User A, types an individual character at their computer, e.g., the first computer 11A, the system communicates that character from the first computing device 11A to other computing devices 11B-11I of individual meeting participants 10B-10I. Each of the individual characters are separately transmitted from the first computing device 11A to the other computing devices 10B-10I in response to individual character input entries received at the first computing device 11A.

As shown in FIG. 5B, when User A provides an input for the letter “H”, code for the letter “H” is transmitted to each remote device 10B-10I in the meeting and displayed in the RTT region of the UI at each remote device 10B-10I. Then, as shown in FIGS. 5C-5K , as User A types each character into the input device of the first device 11A, each character is transmitted to, and displayed on each of the other devices 11B-11I. This includes the transmission of editing characters, such as the delete character, and any other symbol having an assigned ASCII number. The system also maintains the order in which the characters are entered at a device receiving the key input. Thus, if User A enters the sequence H-E-L-L-O, the letters show up in the same sequence on the other devices on a character-by-character basis. The system can perform a verification process to maintain the correct sequence in case the transfer of some individual characters is unduly delayed between the devices.

Also shown in FIG. 5K, the system can also cause each client device to generate a computer-generated voice 331 from a text-to-speech conversion of the received RTT. As applied to the above-described example with respect to FIG. 3 and FIG. 4, this feature includes operations for causing an audio device to produce a computer-generated voice output enunciating one or more phrases formed by the individual RTT characters provided by the first participant and the other individual RTT characters provided by the second participant.

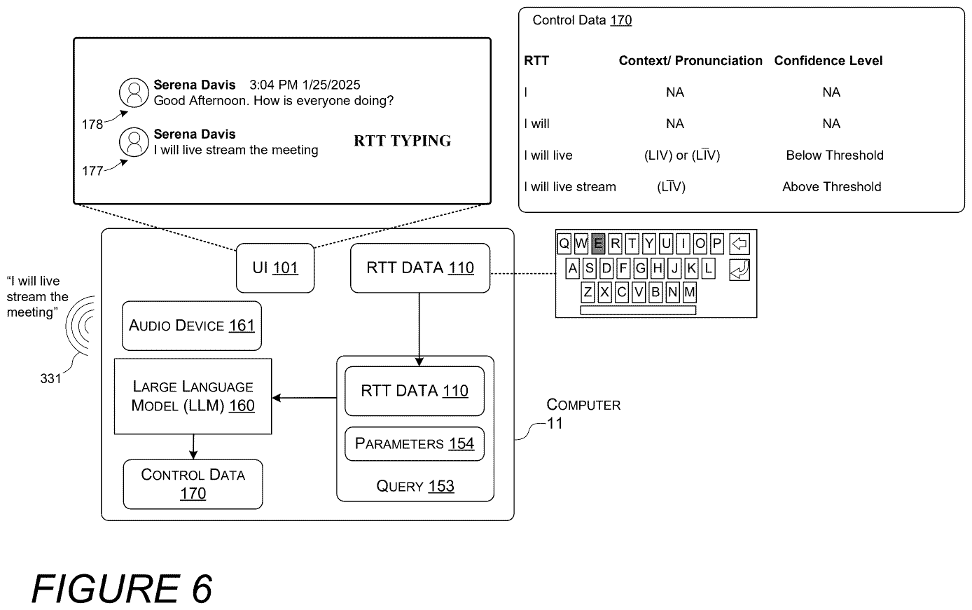

In some embodiments, the computer-generated voice 331 can be generated when the system determines that the RTT forms a complete phrase or sentence. In other embodiments, the computer-generated voice 331 can be invoked by other actions. In one example, the computer-generated voice 331 can be invoked when a user enters the Return key while they are in RTT mode. In other examples, policies can be established to invoke the computer-generated voice 331. For example, a system can define a policy that causes a system to generate the computer-generated voice 331 when certain punctuation characters are entered, such as a period or comma. In yet another example, the computer-generated voice 331 is generated when the system analyzes the RTT and determines a context of the words formed by the RTT, and when the system determines a threshold confidence level of that context. In such embodiments, as described below with respect to FIG. 6, the system can utilize AI models to determine a context from the RTT and a confidence level for that determined context.

The system is also configured to receive a user input to change the tone or mood of the computer-generated voice. In addition, the system can also determine a context based on the phrases formed by the RTT and control the volume, speed, and other characteristics of a computer-generated voice that is used to enunciate the phrases formed by the RTT. The characteristics of a voice can include an accent from a specific culture, particular inflection characteristics, etc. The system can also receive input data indicating preferences of the recipients of the RTT to determine the volume, speed, and other characteristics of a computer-generated voice.

FIG. 6 shows one example of how a large language model (LLM) can be used to generate control data that invokes one or more computers to produce a computer-generated voice 331 from the RTT. As shown in the upper right region of FIG. 6, the system can generate queries as RTT characters are received. As a phrase develops from received RTT, the system can cause the LLM to determine a context and/or a pronunciation for certain words. In this example, as the phrase develops from “I” to “I will live” the system starts to determine options for different meanings of the word “live” and corresponding pronunciations for the word. At this stage of the RTT input, the system can use the LLM to determine that there are two options for the word “live”: which can include either /lIV/ (short “i” sound, rhymes with “give”) with the meaning to exist, be alive, or reside, or /laIV/ (long “i” sound, rhymes with “hive”) with the meaning something happening in real-time. When the system determines a context having a threshold confidence level, the system can cause each client device to produce a computer-generated voice 331 that includes words formed by the RTT. In the present example, when the system sends four words of the RTT to the LLM, the system can then determine a single context or meaning of the word “live” with a threshold confidence level, and generate control data causing the system to generate a voice output with an accurate pronunciation and context for the provided RTT.

As shown in FIG. 6, the system generates a query 153 using the RTT data 110. The query also includes parameters 154 that provide instructions for the LLM 160 to generate control data 170. The parameters can cause the LLM to determine the context from the RTT that has been received and generate a confidence level for that context. In this case, when the RTT only forms three words, it is difficult for the system to determine which meaning is used for the word “live.” Query parameters can include instructions that cause the LLM to determine which definition, e.g., a context of the RTT, that should be used and the correct pronunciation for that word. In this example, given that the first three words of the phrase formed by the RTT cannot provide a suitable context, the system would generate control data indicating a confidence level that is below a threshold and also define two or more pronunciations for the word “live,” and the system would not produce a computer-generated voice 331 from the RTT. However, when the phrase having four words is provided to the LLM, the query can cause the LLM to select one definition for the word, and also provide a level of confidence that exceeds a threshold. In this scenario, the system would generate control data 170 that instructs the system to generate an audio output 331 from an audio device 161, such as a speaker. In some embodiments, the system does not generate the audio output until there is a threshold level of confidence and also when the system can detect a complete thought or a complete a complete sentence. In this example, the system can generate an audio output 331 only processing the first four words formed by the RTT, or alternatively, the system can generate an audio output 331 after the LLM determines that the words form a complete phrase.

As shown in the upper left corner of FIG. 6, the LLM can also be used to determine when a phrase is complete and should be converted from RTT text 177 to a message format 178 with a timestamp. For instance, when the first set of characters is received and the system detects that a full sentence or phrase is generated, or when the RTT participant enters the Return key, the system can convert the phrase “Good afternoon. How is everyone doing?” from displayed RTT text to a message format having a timestamp. The system also acknowledges the RTT users as an “active speaker” so the content shared in RTT is also recorded equitably in meeting records and used in AI models for building summaries, tasks, etc.

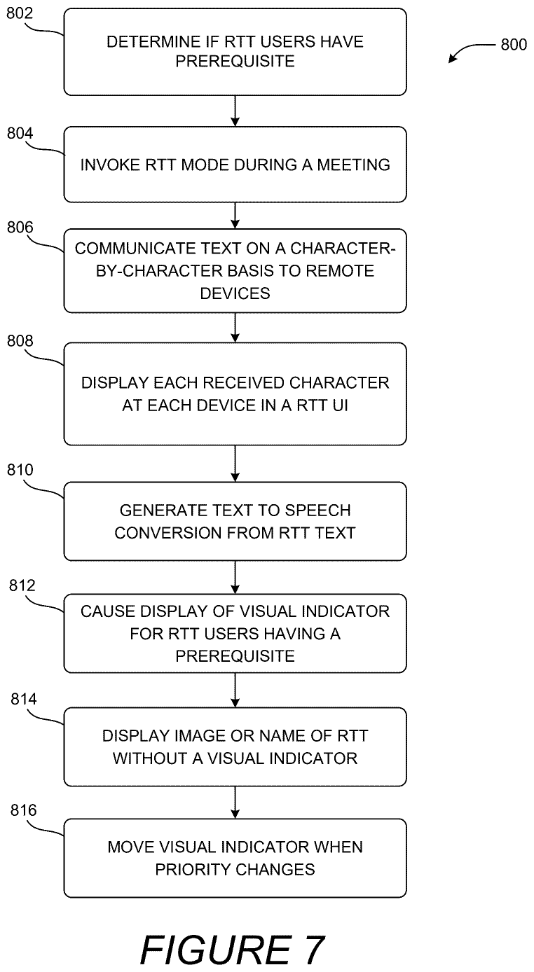

Turning now to FIG. 7, the following section describes aspects of a routine 800 for providing enhanced controls for the display of visual indicators for participants providing real-time text (RTT) is shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following illustration refers to the components depicted in the present application, it can be appreciated that the operations of the routine may be also implemented in many other ways. For example, the routine may be implemented, at least in part, by a processor or circuit of another remote computer (which can be a server) or a local processor or circuit of a local computer (which can be a client device receiving a message or a client device sending the message). Any aspect of the routine, which can include the generation of a prompt, communication of any of the messages with the prompt to an Natural Language Processing (NLP) algorithm, use of an NLP algorithm, or a display of a result generated by an NLP algorithm, can be performed on either a device sending a message, a device receiving a message, or on a server managing communication of the messages for a thread. In addition, one or more of the operations of the routine may alternatively or additionally be implemented, at least in part, by a chipset working alone or in conjunction with other software modules. Any service, circuit or application suitable for providing input data indicating the state of any device may be used in operations described herein.

The routine 800 starts at operation 802, where the system determines if one or more users have a prerequisite. The system can receive an input indicating at least one prerequisite 210A of a first participant 10A. The input can be received from a user input or received by accessing a data structure defining settings 200 that persist across multiple communication sessions for all participants, e.g., the first participant 10A and the second participant 10B. For example, the settings can define at least one prerequisite 210A for the user 10A, and the settings do not define one or more prerequisites 210 for a second participant 10B. In some embodiments, the system can access the settings automatically for particular users, e.g., the first user, in response to the participants e.g., the first participant 10A joining a meeting, e.g., the communication session.

At operation 804, the system invokes RTT mode for a meeting. As shown in FIGS. 2A-2F, RTT mode is invoked in a number of ways. In one embodiment, an input is received for invoking RTT mode. In response, at operation 806, during the communication session, the system invokes a real-time text mode for generating the real-time text 111. The generation of the real-time text 111 includes communicating individual text characters from a first computing device 11A to a number of computing devices 11B-11H of individual meeting participants 10B-10H, wherein each of the individual text characters are separately transmitted from the first computing device 11A to the number of computing devices 10B-10H in response to individual input entries, e.g., keyboard entries, corresponding to each of the individual text characters.

The RTT is communicated and displayed on a character-by-character basis until one or more criteria are met. For instance, the RTT is communicated and displayed on a character-by-character basis until the user providing the RTT stops typing for a predetermined period of time. In the embodiments disclosed herein, the visual indicator is displayed when the RTT starts and remains until the RTT stops, e.g., RTT stops typing for a predetermined period of time. Once a person stops typing for a predetermined period of time, or if the user enters a predetermined key, the system causes the RTT to be stored in a communication stream in a collection of text or a message and additional RTT is not added to that collection or message if additional characters are received. If new characters are received after the person stops typing for a predetermined period of time, the new RTT is entered in a new collection of text or a new message. Each collection of RTT can be time stamped as shown in FIG. 6.

At operation 808, the system causes a display of the individual text characters at the number of computing devices 11B-11H of individual meeting participants. The individual text characters are each displayed as they are received at each of the number of computing devices 11B-11H from the first computing device 11A. For illustrative purposes, a “communication stream” or a “conversation stream” can be a message thread, chat thread, or any other suitable data structure. The communication stream can now be provided to an AI engine as background data or as part of a prompt, or the conversation stream can be used as part of a transcript. A similar process can be used for other users, such as the second user User B 10B, communicating RTT to other meeting participants, e.g., Users 10A, 10C-10H.

In operation 808, the system can generate a meeting UI that shows a stage and RTT. While in the real-time text mode, the system can cause a display of a first user interface arrangement 101 on the devices of each participant, such as the first computing device 11A. The first user interface arrangement 101 can include a first display area 121 reserved for displaying the real-time text 111 and a second display area 122 reserved for at least one of a video stream or an image shared between one or more computing devices 11A-11H participating in the communication session.

At operation 810, the system can generate a computer-generated voice 331 at each client device from a text-to-speech conversion of the received RTT. In some embodiments, the computer-generated voice 331 can be generated when the RTT forms a complete phrase or sentence. In other embodiments, the computer-generated voice 331 can be invoked by other actions. In one example, the computer-generated voice 331 can be invoked when a user enters the Return key when they are in RTT mode. In other examples, policies can be established to invoke the computer-generated voice 331 when certain punctuation characters are entered, or when the system analyzes the RTT and determines a context from the RTT having a threshold confidence level.

At operation 812, the system displays a visual indictor for select participants. For example, as shown in FIG. 3, while the first participant is composing a RTT message or a text message, the system provides a visual indication about the first participant to other participants present in the meeting showing that the first participant is an active speaker if the first participant has a prerequisite. However, in operation 814, an image or user name is not displayed with the visual indicator, e.g., the system does not highlight other users typing using RTT or text messages if they do not have such designations e.g., a user does not have a prerequisite. In some embodiments, the visual indicator 361 is activated when RTT starts, and remains while RTT is being provided, e.g., while the speech is being spoken.

This can include causing a display of the individual text characters and the other individual text characters on a user interface 101 as each of the individual text characters and the other individual text characters are respectively communicated from the first computer device and second the second computing device, the user interface further comprising an image or an identifier of the first participant 10A. The system can then determine that the first participant 10A is associated with at least one prerequisite 210A and the second participant 10B is not associated with the one or more prerequisites 210. In response to determining that the first participant 10A is associated with the at least one prerequisite 210A and the second participant 10B is not associated with the one or more prerequisites 210, displaying a visual element in association with the image or the identifier of the first participant 10A, the visual element indicating an activity status of the first participant 10A. In operation 816, the system can move the visual indictor when the first participant stops typing while the second participant continues to type.

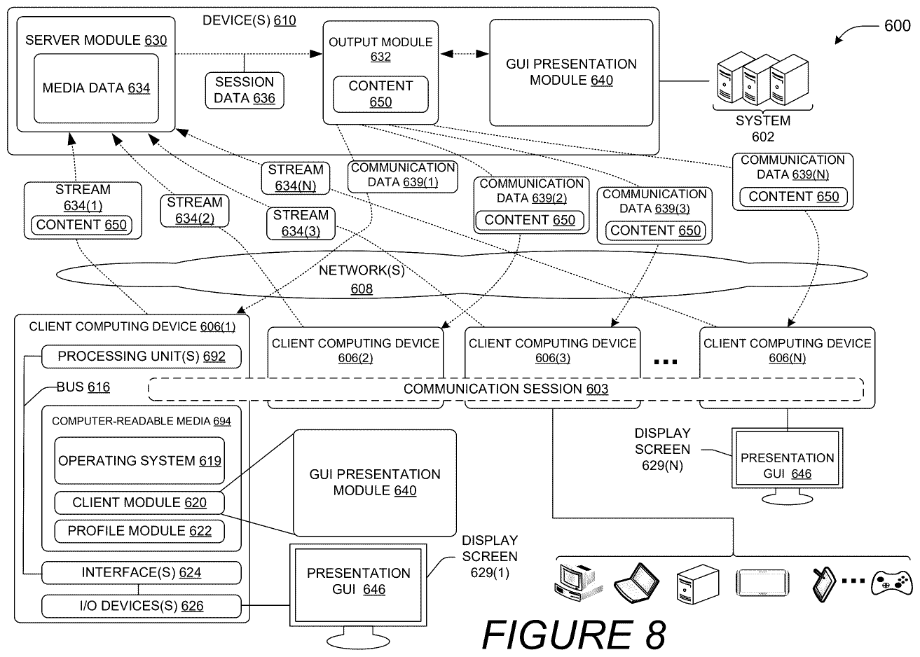

Turning now to FIG. 8, a diagram illustrating an example environment 600 in which a system 602 can implement the disclosed techniques is shown. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, a system 602 may function to collect, analyze, and share data that is displayed to users of a communication session 603. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603. A communication session 603 can include a call, which can be a direct call from a person to others, a communication session 603 can also include a meeting, which is an appointment that is established by a calendar event defining attendees.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A computing system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds can be communicated with the messages.

The system 602 of FIG. 8 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses. Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a vocal input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 8 illustrates that client computing device 606(1) is in some way connected to a display device (e.g., a display screen 629(N)), which can display a UI according to the techniques described herein.

In the example environment 600 of FIG. 8, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 8) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 8, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening”, device such that it only receives content associated with the communication session 603 but does not provide any content to the communication session 603.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may communicate communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/O device 626 on each client computer. The content 650 also include input data from each user, which can be used to control a direction and location of a representation. The content can also include instructions for sharing data and identifiers for recipients of the shared data. Thus, the content 650 is also referred to herein as input data 650 or an input 650.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next).

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

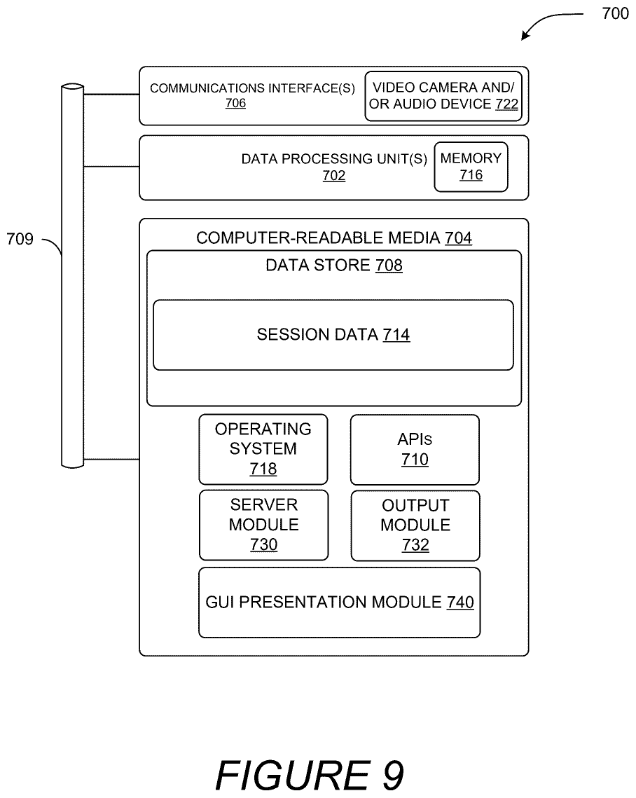

FIG. 9 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. Additionally, or alternatively, the device 700 may represent one of the client computing devices 606.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, includes computer storage media and not communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, computer-readable storage medium, computer-readable storage device, or computer storage medium.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704 includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store the primary calendar and secondary calendar, and other session data that show the status and activity level of each user. The session data can include a total number of participants (e.g., users and/or client computing devices) in a communication session, activity that occurs in the communication session, a list of invitees to the communication session, and/or other data related to when and how the communication session is conducted or hosted. The data store 708 may also include session data 714, such as the meeting objects described herein. The session data 714 can also include video, audio, or other content that can be shared in a meeting. The session data can also include permissions for each user. For example, session data can indicate that past meetings included users having speaker roles and other roles. This data can also indicate preferences, e.g., that a user wants to join meetings with RTT activated for each meeting or only certain events having attributes that meet one more criteria, e.g., with predetermined invitees or meetings having shared content having a predetermined subject. The permissions can define specific instructions that are permitted and restricted during different states of a meeting or call that is in progress. For example, based on a role in a meeting, e.g., organizer or administrator, some users may have permissions to start or stop the RTT mode in a meeting, while others are restricted from such operations.

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) 710 (APIs) configured to expose the functionality and the data of the device 700 to other devices. Additionally, the computer-readable media 704 includes one or more modules such as the server module 730, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

The following Clauses are to supplement the present disclosure.
Clause A: A computing system (700) for controlling a display of visual indicators providing attribution to participants having a prerequisite while actively typing a text message or actively communicating real-time text during a communication session for a plurality of participants (10A-10I), the computing system (700) comprising: one or more processing units (702); and a computer-readable storage medium (704) having encoded thereon computer-executable instructions to cause the one or more processing units (702) to: receive an input indicating at least one prerequisite (210A) of a first participant (10A), the input received from a user input or received by accessing settings (200) that persist across multiple communication sessions for the first participant (10A), the settings define the at least one prerequisite (210A) for the user (10A), wherein the access to the settings is performed automatically by the system (100) in response to the first participant (10A) joining the communication session, the settings not defining one or more prerequisites (210) for a second participant (10B); determine that the first participant (10A) is associated with the at least one prerequisite (210A) while the first participant is in a real-time text mode actively communicating real-time text or actively typing a text message in message mode, and determining that the second participant (10B) is not associated with the one or more prerequisites (210); and in response to determining that the first participant (10A) is associated with the at least one prerequisite (210A) while the first participant is in the real-time text mode actively communicating real-time text or actively typing a text message in message mode, and determining that the second participant (10B) is not associated with the one or more prerequisites (210), display a visual element in association with the image or the identifier of the first participant (10A), the visual element indicating an active text input status of the first participant (10A), wherein an identifier or an image of the second participant is displayed without an associated visual element indicating a text input status of the second participant.
Clause B: The computing system of Clause A, wherein the instructions further cause the one or more processing units to: determine that the first participant stopped communicating individual text characters for a predetermined period of time; and in response to determining that the first participant stopped communicating individual text characters for the predetermined period of time, and in response to determining that the second participant is still communicating the other individual text characters within the predetermined period of time: remove the display of the visual element in association with the image or the identifier of the first participant (10A); and cause a display of a second visual element in association with an image or an identifier of the second participant (10B).
Clause C: The computing system of Clauses A and B, wherein the instructions further cause the one or more processing units to: cause an audio device to produce a computer-generated voice output enunciating one or more phrases formed by the individual text characters provided by the first participant and the other individual text characters provided by the second participant.
Clause D: The computing system of Clauses A through C, wherein the instructions further cause the one or more processing units to: generate a query that includes the individual text characters provided by the first participant and the other individual text characters provided by the second participant, and query parameters causing a LLM to generate control data to determine a context to a phrase of the individual text characters and the other individual text characters, and a confidence level for the context; determine that the confidence level is above a threshold; and in response to determining that the confidence level is above the threshold, causing an audio device to produce a computer-generated voice output enunciating one or more phrases that is using the determined context, the computer-generated voice output enunciating one or more phrases formed by the individual text characters provided by the first participant and the other individual text characters provided by the second participant.
Clause E: The computing system of Clauses A through D, wherein the instructions further cause the one or more processing units to: restrict the display of one or more visual elements indicating an active speaker status of the second participant in response to determining that the second participant is not associated with the one or more prerequisites.
Clause F: The computing system of Clauses A through E, wherein determining that the first participant (10A) is associated with the at least one prerequisite (210A) and the second participant (10B) is not associated with the one or more prerequisites (210) is performed in response to the first participant and the second participant invoking the real-time text mode, wherein the system does not communicate text characters on a character-by-character basis when the system is not in real-time text mode.
Clause G: The computing system of Clauses A through F, wherein the instructions further cause the one or more processing units to: determine that the first participant and the second participant are active participants for the communication session; and in response to determining that the first participant and the second participant are active participants for the communication session, store the individual text characters from the first participant and the other individual text characters from the second participant in at least one of a meeting summary, a meeting transcript, a live caption, or an input to AI query for analysis of the communication session.
Clause H: A computer-implemented method for controlling a display of visual indicators providing attribution to participants having a prerequisite while actively typing a text message or actively communicating real-time text during a communication session for a plurality of participants (10A-10I), the computer-implemented method for execution on a system (100), the computer-implemented method comprising: receiving an input indicating at least one prerequisite (210A) of a first participant (10A), the input received from a user input or received by accessing settings (200) that persist across multiple communication sessions for the first participant (10A), the settings defining the at least one prerequisite (210A) for the user (10A), wherein the access to the settings is performed automatically by the system (100) in response to the first participant (10A) joining the communication session, the settings not defining one or more prerequisites (210) for a second participant (10B); determining that the first participant (10A) is associated with the at least one prerequisite (210A); and in response to determining that the first participant (10A) is associated with the at least one prerequisite (210A): while the first participant is in a real-time text mode actively communicating real-time text or actively typing a text message in a message mode, displaying a visual element in association with an image or an identifier of the first participant (10A), the visual element indicating an active text input status of the first participant (10A), wherein the real-time text mode includes communication of individual characters from a computing device of the first participant to other devices of other participants of the communication session on a character-by-character basis, and wherein the message mode includes communication of a collection of characters sent in the text message in response to a predetermined input for sending the text message; and while the first participant is not in the real-time text mode actively communicating real-time text or not actively typing the text message, displaying the image or the identifier of the first participant (10A) without the visual element; in response to determining that the second participant (10B) is not associated with the one or more prerequisites (210): while the second participant is in the real-time text mode actively communicating real-time text or actively typing the text message, displaying an identifier or an image of the second participant without an associated visual element indicating an active text input status of the second participant.
Clause I: The computer-implemented method of Clause H, further comprising: determining that the first participant stopped communicating individual text characters for a predetermined period of time; and in response to determining that the first participant stopped communicating individual text characters for the predetermined period of time, and in response to determining that the second participant is still communicating the other individual text characters within the predetermined period of time: removing the display of the visual element in association with the image or the identifier of the first participant (10A); and causing a display of a second visual element in association with an image or an identifier of the second participant (10B).
Clause J: The computer-implemented method of Clauses H and I, further comprising: causing an audio device to produce a computer-generated voice output enunciating one or more phrases formed by the individual text characters provided by the first participant and the other individual text characters provided by the second participant.
Clause K: The computer-implemented method of Clauses H and J, further comprising: generating a query that includes the individual text characters provided by the first participant and the other individual text characters provided by the second participant, and query parameters causing a LLM to generate control data to determine a context to a phrase of the individual text characters and the other individual text characters, and a confidence level for the context; determining that the confidence level is above a threshold; and in response to determining that the confidence level is above the threshold, causing an audio device to produce a computer-generated voice output enunciating one or more phrases that is using the determined context, the computer-generated voice output enunciating the individual text characters provided by the first participant and the other individual text characters provided by the second participant.
Clause L: The computer-implemented method of Clauses H and K, further comprising: restricting the display of one or more visual elements indicating an active speaker status of the second participant in response to determining that the second participant is not associated with the one or more prerequisites.
Clause M: The computer-implemented method of Clauses H and K, wherein determining that the first participant (10A) is associated with the at least one prerequisite (210A) and the second participant (10B) is not associated with the one or more prerequisites (210) is performed in response to the first participant and the second participant invoking the real-time text mode, wherein the system does not communicate text characters on a character-by-character basis when the system is not in real-time text mode, wherein the method further comprises: during the communication session, invoking a real-time text mode for generating the real-time text (111) for the first participant (10A) and the second participant (10B), the generation of the real-time text (111) comprising: communicating individual text characters from a first computing device (11A) to a first set of computing devices (11B-11I) of a first set of meeting participants (10B-10I) on a character-by-character basis, wherein each of the individual text characters are separately transmitted from the first computing device (11A) to the first set of computing devices (10B-10I) in response to individual character input entries entered at the first computing device (11A), communicating other individual text characters from a second computing device (11B) to a second set of computing devices (11B-11I) of a second set of meeting participants (10A, 10C-10I) on a character-by-character basis, wherein each of the individual text characters are separately transmitted from the second computing device (11B) to the second set of computing devices (10A, 10C-10I) in response to individual character input entries entered at the second computing device (11B), and causing a display of the individual text characters and the other individual text characters on a user interface (101) as each of the individual text characters and the other individual text characters are respectively communicated from the first computer device and second the second computing device, the user interface further comprising an image or an identifier of the first participant (10A).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

I/We claim:

1. A computer-implemented method for controlling a display of visual indicators providing attribution to participants having a prerequisite while actively typing a text message or actively communicating real-time text during a communication session for a plurality of participants, the computer-implemented method for execution on a system, the computer-implemented method comprising:
receiving an input indicating at least one prerequisite of a first participant, the input received from a user input or received by accessing settings that persist across multiple communication sessions for the first participant, the settings defining the at least one prerequisite for the user, wherein the access to the settings is performed automatically by the system in response to the first participant joining the communication session, the settings not defining one or more prerequisites for a second participant;
determining that the first participant is associated with the at least one prerequisite; and
in response to determining that the first participant is associated with the at least one prerequisite:
while the first participant is in a real-time text mode actively communicating real-time text or actively typing a text message in a message mode, displaying a visual element in association with an image or an identifier of the first participant, the visual element indicating an active text input status of the first participant, wherein the real-time text mode includes communication of individual characters from a computing device of the first participant to other devices of other participants of the communication session on a character-by-character basis, and wherein the message mode includes communication of a collection of characters sent in the text message in response to a predetermined input for sending the text message; and
while the first participant is not in the real-time text mode actively communicating real-time text or not actively typing the text message, displaying the image or the identifier of the first participant without the visual element;
in response to determining that the second participant is not associated with the one or more prerequisites:
while the second participant is in the real-time text mode actively communicating real-time text or actively typing the text message, displaying an identifier or an image of the second participant without an associated visual element indicating an active text input status of the second participant.

2. The computer-implemented method of claim 1, further comprising:
determining that the first participant stopped communicating individual text characters for a predetermined period of time; and
in response to determining that the first participant stopped communicating individual text characters for the predetermined period of time, and in response to determining that the second participant is still communicating the other individual text characters within the predetermined period of time:
removing the display of the visual element in association with the image or the identifier of the first participant; and
causing a display of a second visual element in association with an image or an identifier of the second participant.

3. The method of claim 1, further comprising: causing an audio device to produce a computer-generated voice output enunciating one or more phrases formed by the individual text characters provided by the first participant and the other individual text characters provided by the second participant.

4. The method of claim 1, further comprising:
generating a query that includes the individual text characters provided by the first participant and the other individual text characters provided by the second participant, and query parameters causing a LLM to generate control data to determine a context to a phrase of the individual text characters and the other individual text characters, and a confidence level for the context;
determining that the confidence level is above a threshold; and
in response to determining that the confidence level is above the threshold, causing an audio device to produce a computer-generated voice output enunciating one or more phrases that is using the determined context, the computer-generated voice output enunciating the individual text characters provided by the first participant and the other individual text characters provided by the second participant.

5. The method of claim 1, further comprising: restricting the display of one or more visual elements indicating an active speaker status of the second participant in response to determining that the second participant is not associated with the one or more prerequisites.

6. The method of claim 1, wherein determining that the first participant is associated with the at least one prerequisite and the second participant is not associated with the one or more prerequisites is performed in response to the first participant and the second participant invoking the real-time text mode, wherein the system does not communicate text characters on a character-by-character basis when the system is not in real-time text mode, wherein the method further comprises:
during the communication session, invoking a real-time text mode for generating the real-time text for the first participant and the second participant, the generation of the real-time text comprising:
communicating individual text characters from a first computing device to a first set of computing devices of a first set of meeting participants on a character-by-character basis, wherein each of the individual text characters are separately transmitted from the first computing device to the first set of computing devices in response to individual character input entries entered at the first computing device,
communicating other individual text characters from a second computing device to a second set of computing devices of a second set of meeting participants (10A, 10C-10I) on a character-by-character basis, wherein each of the individual text characters are separately transmitted from the second computing device to the second set of computing devices (10A, 10C-10I) in response to individual character input entries entered at the second computing device, and
causing a display of the individual text characters and the other individual text characters on a user interface as each of the individual text characters and the other individual text characters are respectively communicated from the first computer device and second the second computing device, the user interface further comprising an image or an identifier of the first participant.

7. The method of claim 1, further comprising:
determining that the first participant and the second participant are active participants for the communication session; and
in response to determining that the first participant and the second participant are active participants for the communication session, storing the individual text characters from the first participant and the other individual text characters from the second participant in at least one of a meeting summary, a meeting transcript, a live caption, or an input to AI query for analysis of the communication session.

8. A computing system for controlling a display of visual indicators providing attribution to participants having a prerequisite while actively typing a text message or actively communicating real-time text during a communication session for a plurality of participants, the computing system comprising:
one or more processing units; and
a computer-readable storage medium having encoded thereon computer-executable instructions to cause the one or more processing units to:
receive an input indicating at least one prerequisite of a first participant, the input received from a user input or received by accessing settings that persist across multiple communication sessions for the first participant, the settings defining the at least one prerequisite for the user, wherein the access to the settings is performed automatically by the system in response to the first participant joining the communication session, the settings not defining one or more prerequisites for a second participant;
determine that the first participant is associated with the at least one prerequisite; and
in response to determining that the first participant is associated with the at least one prerequisite:
while the first participant is in a real-time text mode actively communicating real-time text or actively typing a text message in a message mode, display a visual element in association with an image or an identifier of the first participant, the visual element indicating an active text input status of the first participant, wherein the real-time text mode includes communication of individual characters from a computing device of the first participant to other devices of other participants of the communication session on a character-by-character basis, and wherein the message mode includes communication of a collection of characters sent in the text message in response to a predetermined input for sending the text message; and
while the first participant is not in the real-time text mode actively communicating real-time text or not actively typing the text message, display the image or the identifier of the first participant without the visual element;
in response to determining that the second participant is not associated with the one or more prerequisites:
while the second participant is in the real-time text mode actively communicating real-time text or actively typing the text message, display an identifier or an image of the second participant without an associated visual element indicating an active text input status of the second participant.

9. The computing system of claim 8, wherein the instructions further cause the one or more processing units to:
determine that the first participant stopped communicating individual text characters for a predetermined period of time; and
in response to determining that the first participant stopped communicating individual text characters for the predetermined period of time, and in response to determining that the second participant is still communicating the other individual text characters within the predetermined period of time:
remove the display of the visual element in association with the image or the identifier of the first participant; and
cause a display of a second visual element in association with an image or an identifier of the second participant.

10. The computing system of claim 8, wherein the instructions further cause the one or more processing units to: cause an audio device to produce a computer-generated voice output enunciating one or more phrases formed by the individual text characters provided by the first participant and the other individual text characters provided by the second participant.

11. The computing system of claim 8, wherein the instructions further cause the one or more processing units to:
generate a query that includes the individual text characters provided by the first participant and the other individual text characters provided by the second participant, and query parameters causing a LLM to generate control data to determine a context to a phrase of the individual text characters and the other individual text characters, and a confidence level for the context;
determine that the confidence level is above a threshold; and
in response to determining that the confidence level is above the threshold, causing an audio device to produce a computer-generated voice output enunciating one or more phrases that is using the determined context, the computer-generated voice output enunciating one or more phrases formed by the individual text characters provided by the first participant and the other individual text characters provided by the second participant.

12. The computing system of claim 8, wherein the instructions further cause the one or more processing units to: restrict the display of one or more visual elements indicating an active speaker status of the second participant in response to determining that the second participant is not associated with the one or more prerequisites.

13. The computing system of claim 8, wherein determining that the first participant is associated with the at least one prerequisite and the second participant is not associated with the one or more prerequisites is performed in response to the first participant and the second participant invoking the real-time text mode, wherein the system does not communicate text characters on a character-by-character basis when the system is not in real-time text mode.

14. The computing system of claim 8, wherein the instructions further cause the one or more processing units to:
determine that the first participant and the second participant are active participants for the communication session; and
in response to determining that the first participant and the second participant are active participants for the communication session, store the individual text characters from the first participant and the other individual text characters from the second participant in at least one of a meeting summary, a meeting transcript, a live caption, or an input to AI query for analysis of the communication session.

15. A computer-readable storage medium having encoded thereon computer-executable instructions for controlling a display of visual indicators providing attribution to participants having a prerequisite while actively typing a text message or actively communicating real-time text during a communication session for a plurality of participants, the computer-executable instructions configured to cause one or more processing units of a computing system to:
receive an input indicating at least one prerequisite of a first participant, the input received from a user input or received by accessing settings that persist across multiple communication sessions for the first participant, the settings defining the at least one prerequisite for the user, wherein the access to the settings is performed automatically by the system in response to the first participant joining the communication session, the settings not defining one or more prerequisites for a second participant;
determine that the first participant is associated with the at least one prerequisite; and
in response to determining that the first participant is associated with the at least one prerequisite:
while the first participant is in a real-time text mode actively communicating real-time text or actively typing a text message in a message mode, display a visual element in association with an image or an identifier of the first participant, the visual element indicating an active text input status of the first participant, wherein the real-time text mode includes communication of individual characters from a computing device of the first participant to other devices of other participants of the communication session on a character-by-character basis, and wherein the message mode includes communication of a collection of characters sent in the text message in response to a predetermined input for sending the text message; and
while the first participant is not in the real-time text mode actively communicating real-time text or not actively typing the text message, display the image or the identifier of the first participant without the visual element;
in response to determining that the second participant is not associated with the one or more prerequisites:
while the second participant is in the real-time text mode actively communicating real-time text or actively typing the text message, display an identifier or an image of the second participant without an associated visual element indicating an active text input status of the second participant.

16. The computer-readable storage medium of claim 15, wherein the instructions further cause the one or more processing units to:
determine that the first participant stopped communicating individual text characters for a predetermined period of time; and
in response to determining that the first participant stopped communicating individual text characters for the predetermined period of time, and in response to determining that the second participant is still communicating the other individual text characters within the predetermined period of time:
remove the display of the visual element in association with the image or the identifier of the first participant; and
cause a display of a second visual element in association with an image or an identifier of the second participant.

17. The computer-readable storage medium of claim 15, wherein the instructions further cause the one or more processing units to: cause an audio device to produce a computer-generated voice output enunciating one or more phrases formed by the individual text characters provided by the first participant and the other individual text characters provided by the second participant.

18. The computer-readable storage medium of claim 15, wherein the instructions further cause the one or more processing units to:
generate a query that includes the individual text characters provided by the first participant and the other individual text characters provided by the second participant, and query parameters causing a LLM to generate control data to determine a context to a phrase of the individual text characters and the other individual text characters, and a confidence level for the context;
determine that the confidence level is above a threshold; and
in response to determining that the confidence level is above the threshold, causing an audio device to produce a computer-generated voice output enunciating one or more phrases that is using the determined context, the computer-generated voice output enunciating one or more phrases formed by the individual text characters provided by the first participant and the other individual text characters provided by the second participant.

19. The computer-readable storage medium of claim 15, wherein the instructions further cause the one or more processing units to: restrict the display of one or more visual elements indicating an active speaker status of the second participant in response to determining that the second participant is not associated with the one or more prerequisites.

20. The computer-readable storage medium of claim 15, wherein determining that the first participant is associated with the at least one prerequisite and the second participant is not associated with the one or more prerequisites is performed in response to the first participant and the second participant invoking the real-time text mode, wherein the system does not communicate text characters on a character-by-character basis when the system is not in real-time text mode.
